(19) United States
(12) Patent Application Publication
(10) Pub. No.: US 2011/0307341 A1
(43) Pub. Date: Dec. 15, 2011

(54) POST-CLICK CALLING LANDING-PAGES

(76) Inventors: Iddo Eli Zohar, Tel Aviv (IL); Shai David Zohar, Moshav Mishmeret (IL)

(21) Appl. No.: 13/138,469

(22) PCT Filed: Feb. 22, 2010
(86) PCT No.: PCT/IB2010/050769

§ 371 Date: Aug. 22, 2011

(30) Foreign Application Priority Data
Feb. 22, 2009 (US) 61154401

(51) Int. Cl. G06Q 30/00

(52) U.S. Cl. 705/14.73

(57) ABSTRACT

A system, a method and a landing-page container enabling to activate and de-activate a calling tool, which can be incorporated in the landing-page container together with an original page content, where the calling tool enables initiating a call between an advertiser and at least one user. The calling tool may be activated according to at least one predefined activation condition and rules. The landing-page container may be launched using a web link, to replace the original content web link, containing the original content web link as a parameter, to allow the integration of the calling tool in the redirection from one or more ads or network pages such as web pages. The call can be initiated once the user clicks or hovers over a predefined area on the container such as a call indicator to activate the calling tool in the container.

### FIELD OF THE INVENTION

The present invention relates generally to the field of Internet ads and their landing-pages and more particularly to ads containing hyperlinks and landing-pages, mini-sites and web-pages with telephonic solutions.

### BACKGROUND OF THE INVENTION

Internet ads are a form of electronic advertising, which enables embedding the ad into a network page such as a web-page. The ad, appearing on a web page of one or more external websites, usually redirects to the advertiser's website (referred to hereinafter as the “landing-page”). The ads are intended to attract users who view network pages in which the ads are embedded to follow the hyper-link of the ad (usually by clicking through the ad using the mouse) and to view the web-page or the landing-page associated with this ad. The same ad may be embedded in more than one page of more than one website or communication network and adaptations may be made to adapt the ad to the network or the website pages definitions and requirements.

An ad may be a rich media file comprising audio, graphic, video and/or animation advertising content, employing content technologies such as, for example, Java, Silverlight, Flash, Shockwave and the like, as known in the art, or alternatively may be a simple text ad containing a hyper-link or an image containing a hyper-link (e.g. using the HTML anchor tag).

Ads are usually distributed by an ad server which embeds the ad and the ad warping code in the external websites according to various parameters such as the characteristics of the external website audience, the type of technology being in used by this website and the way in which the interaction with the ad should be counted and stored.

The landing-page associated with the ad usually provides the user who clicks the ad with more information about the value proposition contained in the ad and usually designed to motivate the user to perform an action such as buying or ordering a product or service.

In order to achieve this goal, many landing-pages provides the users with the option to contact the advertiser, such as a contact-us form, a built-in chat module, a click-to-call button or just publishing a public phone-number that is intended for the user to call the advertiser.

In cases were the contact option is provided by another business entity, the advertiser needs to modify the code or the content of the web-page, usually by an insertion of code provided by the other business entity into the web-page, or by performing other sort of integration between the original content and the contact option. In other cases, were the advertiser does not use a foreign company to allow an interactive contact options, the advertiser would need to develop and embed such a code to be integrated in the web-page.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram schematically illustrating a system for supporting redirected landing-pages with add-on calling tools, according to some embodiments of the invention;

FIG. 2 is a block diagram schematically illustrating the system's calling tool embedded in the redirected landing-page.

FIG. 3A is a flowchart, schematically illustrating a server-side based method for redirection to and creation of landing-page containers with add-on calling tools, according to some embodiments of the invention.

FIG. 3B is a flowchart, schematically illustrating a client-side based method for redirection to and creation of landing-page containers with add-on calling tools, according to some embodiments of the invention.

FIG. 4 is a block diagram, schematically illustrating a calling landing-page container with an input interface, according to some embodiments of the invention;

FIG. 5 is a flowchart, schematically illustrating a method for activation and initiation of a call through a landing-page calling tool, according to some embodiments of the invention;

FIG. 6 is a flowchart, schematically illustrating a method for activation and initiation of a call through a landing-page's input interface, according to some embodiments of the invention; and

FIG. 7 is a block diagram, schematically illustrating an ad generator and a calling landing-page customization tool, according to some embodiments of the invention

### DETAILED DESCRIPTIONS OF SOME EMBODIMENTS OF THE INVENTION

The present invention, in some embodiments thereof, provides a system 1000, a method and a landing-page container 100 comprising original content 110 that can be incorporated with an add-on calling tool 120.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

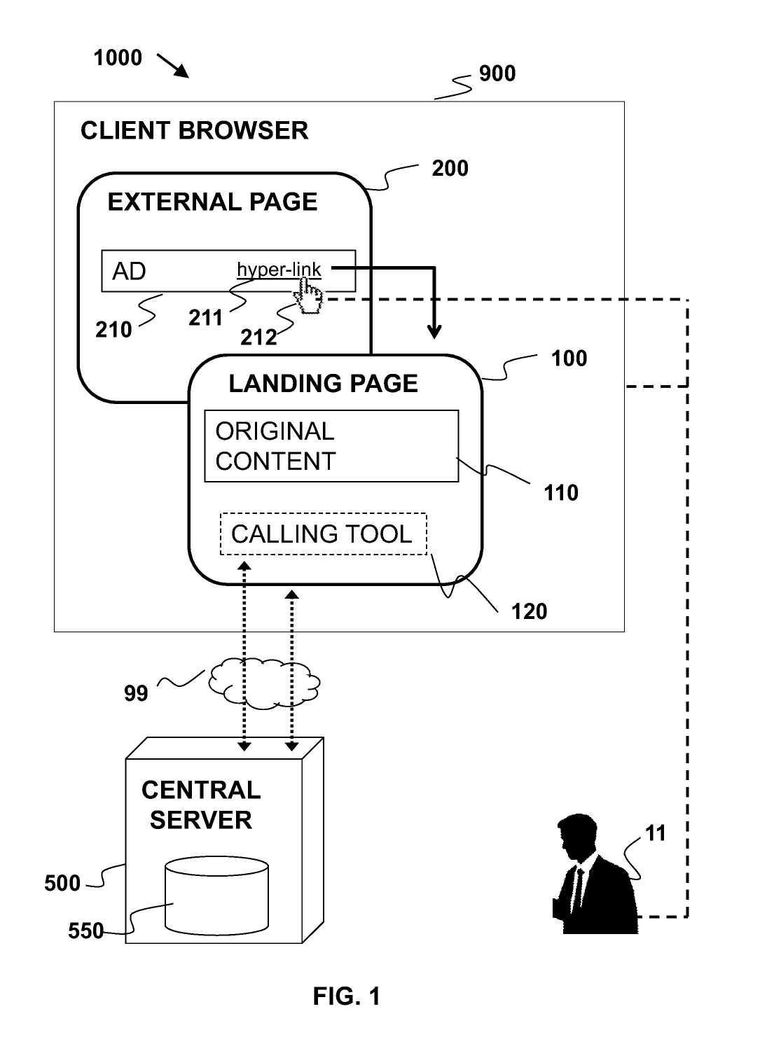

Reference is now made to FIG. 1, which schematically illustrates a system for supporting redirected landing-pages with add-on calling tools, according to some embodiments of the invention. According to these embodiments, the system 1000 may comprise at least some of: an external web page 200; at least one ad 210; at least one container landing-page 100; at least one central server 500; at least one database 550; at least one advertiser's communication device 20; at least one call system 600 and at least one user's communication device 10.

According to some embodiments of the invention, as illustrated in FIG. 1, the ad 210 may be embedded in the external network page 200. The container landing-page 100 may comprise original content 110 and an add-on calling tool 120.

According to some embodiments of the invention, the ad 210 content may be presented in the external web page in any media and method known in art (such as aural, visual, textual, animated, graphical and the like). The ad 210 content may be any known computer code/script employing any content technology known in the art such as, for example, Java, Silverlight, Flash, Shockwave and the like.

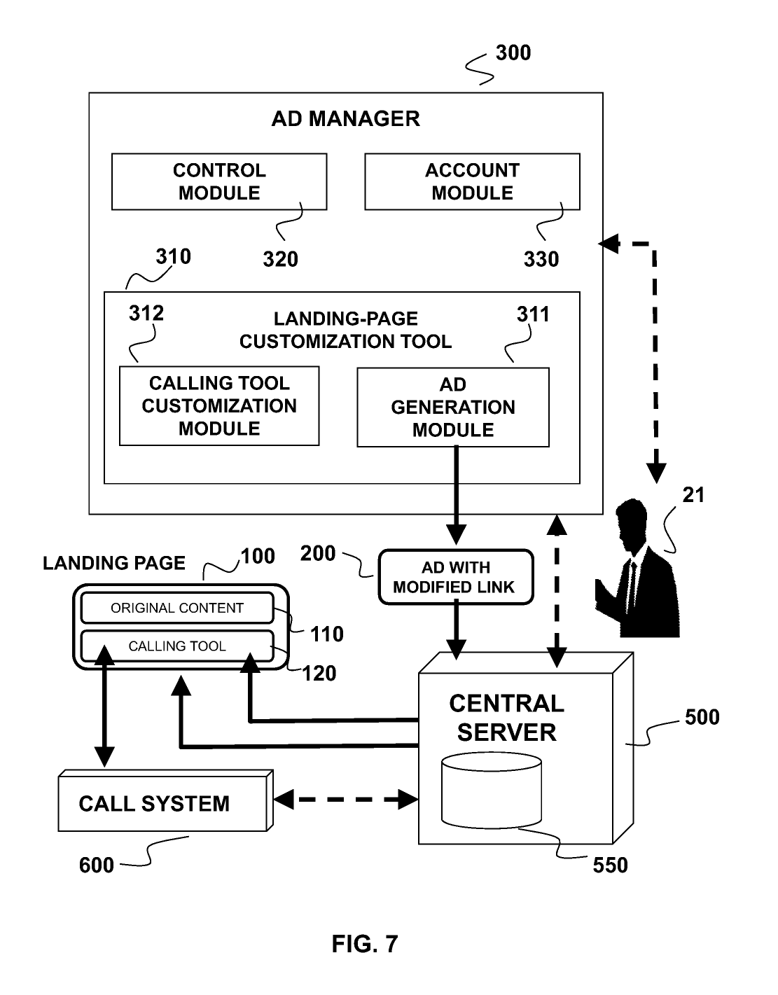

The ad 210 may contain a web link 211 originally redirecting the client browser 900 to display the original content 110 (e.g. upon clicking the link with mouse pointer 212). This web link may be altered to display the container landing page 100 instead of original content 110, as the link may contain the original content 110's web link passed as a parameter in the modified web link. For example, a text ad using an anchor tag with the hyperlink: http://www.original-content-110.com may be modified to the hyperlink: http://www.landing-page-container-100.com?url=http://www.original-content-110.com. This modification may be done as ad 210 is served in the external page 200 by an ad server, during the ad creation process, using a landing-page customization module as described in FIG. 7 hereinafter, automatically by the external web page scripts or in any other method known in the art.

According to some embodiments of the invention, as illustrated in FIG. 1, once ad 210 may be clicked, user 11 is redirected to the landing-page container 100 served by server 500. Landing-page container 100 may present and/or embed the original content 110 which may be passed as a parameter in the hyperlink 211 together with calling tool 120. The original content 110 and the calling tool 120 may be presented by overlapping and utilizing same page area, or alternatively displayed aside one another in landing-page container 100 for supporting the redirected landing-page with an add-on calling instant functionality. In some embodiments of the present invention, the original content 110 may be altered to support a proper display, such as overlapping, with the calling-tool 120, such as, for example, modifying transparency properties, modifying background colors, modifying z-axe precedence and the like.

The embedment of the original content 110 and/or the calling-tool 120 can be done in any method known in the art, for example, in Internet html pages, the original content 110 may be contained within an iframe tag while the calling-tool 120 may be embed normally in web page 100. Another example may be using a frameset in web page 100 where both the original content 110 and the calling tool 120 are contained within different frame tags. Other embedding example may be to present both 100 and 120 contents in different movie-clips, sprits or layers while web page 100 is configured to display a rich-media embedded component or technology known in the art such as Flash, Silverlight, Java applet, etc.

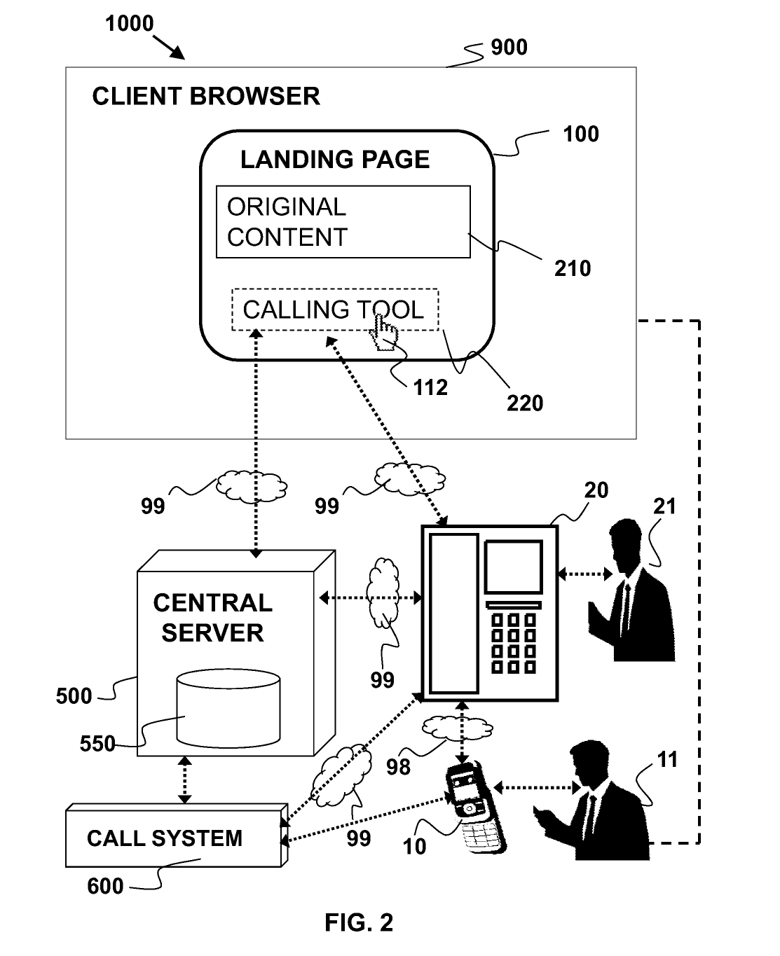

Reference is now made to FIG. 2, which is a block diagram schematically illustrating the system's calling tool embedded in the redirected landing-page. According to some embodiments of the invention, as illustrated in FIG. 2, the calling tool 120 may enable initiating a call between a predefined advertiser's communication device 20 and at least one user's communication device 10, where the calling tool 120 can be activated, deactivated, presented or removed, according to at least one predefined activation condition. The calling tool 120 may be enabled in the banner 100 according to predefined enablement rules, which include at least one activation condition enabling to activate the calling tool 120 upon validation of the fulfillment of the at least one activation condition.

The activation condition(s) activating and deactivating the calling applicability and the calling tool 120 or enabling to either present or remove the indication of the activation tool 120 in the container landing-page 100 may be any condition(s) predefined in the system 1000 either—

(A) Conditions depending on events that are carried out by the user 11 such as, for instance, at least one of:

(1) a condition defining that the calling-tool 120 will be enabled or disabled for users with a specific calling tool usage history (e.g. disabled according to miss-use or fraud patterns such as invalid phone-numbers).
(2) a condition defining that the calling-tool 120 will be enabled or disabled for users with a specific calling history using the tool (e.g. enabled for users that made a call less than a month ago from specific dialing prefix and the call duration was more than a minute).
(B) Conditions depending on events that are predefined by the advertiser 21 retrieved from the server 500 and stored in database 550 such as, for example, at least one of:
(1) automatic activation and deactivation of the calling tool 120 according to, for example, a predefined scheduling defined by the advertiser 21;
(2) automatic activation and deactivation of the calling tool 120 according to, for example, the number of concurrent calls made by other calling-tools 120 in other container landing-pages instances 100 directed to advertiser 21 using network 98 compared to a predefined maximum limit defined by the advertiser 21.
(3) a pre-paid balance of the advertiser's account;

(C) Condition related to the original content 110 or the browser 900 in, such as, for instance, at least one of:

(1) the web address of the original content published together with the calling tool;
(2) the IP address of the client viewing the landing-page;
(3) the geographic location of the client viewing the landing-page;
(4) the original referral domain (e.g. the external page 200 of ad 210).

(D) and/or any other conditions (either automotive or interactive) enabling to activate and deactivate, the calling tool 120 and thereby enabling and disenabling (respectively) the ability of the tool 120 to initiate communication between the user 11 and the advertiser 21 (e.g. by initiating a call between their devices 10 and 20).

Once calling tool 120 is enabled, it can be presented immediately as available to user within the landing-page area 100, or alternatively it may be hidden and be displayed upon user's 11 interaction with the web-page (e.g. hovering over a specific region using cursor 50) or upon user's 11 interaction with an indication symbol (e.g. hovering over a graphical phone symbol, Clicking a “Make a Call” text indicator using cursor 50, etc).

In some embodiments of the present invention, the data may not exclusively be saved in database 550 but rather stored locally on user 11's machine, for example using Internet cookie or a Flash™ Local shared object (LSO) in order to customize the conditions and validation process to the user-level 11.

The original content 110 of the landing-page container 100 may be presented whereas the calling tool 120 indication (e.g. icon, options and the like) may only be presented or displayed once the calling tool 120 is activated (meaning once the activation condition(s) are verified). This means that the landing-page 100 may have dual functioning: the landing-page container 100 may behave as a regular landing-page, without any presence of the calling tool 120, or as a “calling landing-page”, allowing both the original content 110 and the calling tool 120 to be available for the user 11.

Additionally or alternatively, the calling tool 120 may have a turning-off option for disenabling the calling tool 120 or can be turned off according to the user 11 interaction with the container landing-page 100 (e.g. navigation out of the original landing-page).

Each container landing-page 100 may be redirected from one or more network external pages 200 (e.g. web pages 200) associated with one or more ads such as 210 containing one or more types of links such as 211 in one or more types of web pages 200 and/or communication networks 99. Furthermore, multiple landing-page containers 100 may be distributed and redirected from a multiplicity of network pages 200, being operated and controlled, for example, by at least one ad-server as known in the art, while the calling tools 120 in each container landing-page 100 may be subject to a centralized control server 500 over network 99 in the system 1000 regarding the enablement of the calling tool 120 (e.g. activation or deactivation of the calling tools 120 and presentation or hiding of the tool's 120 indicator).

The user 11 may be any user 11 using one or more communication networks 99 that can use and view external network pages 200 with ads 210 embedded therein.

The advertiser 21 may be any entity that publishes through the ads 210 and/or that maintains the landing-page original content 110 and linked to it in various pages 200 such as a business, a company, one or more persons and the like, as known in the art.

The communication devices 10 and 20 may be any communication devices known in the art enabling communication through one or more communication networks 98 comprising means for handling a voice conversation. In some cases it may be that the communication device 10 is also capable of viewing and interacting with the client browser 900 by surfing, browsing and using the device 10 and 20 for retrieving, inputting and viewing of data or any other functionality known in the art enabling to retrieve and input information (e.g. video, audio, visual display and the like). In such cases, communication networks 99 and 98 may be the same communication network (e.g. the Internet) enabling for both interaction with the landing-page 100 and handling of the voice conversation with communication devices 10 and 20. For example, each device 20 or 10 may be at least one of: a PC computer, a laptop with internet access, a mobile phone with WAP access, an iPhone, an i-pod and the like, using any communication and interface technologies known in the art.

The central server 500 in the system 1000 may enable adapting the calling tool 120 configuration to each page 200, original content 110 or user device 10. In some embodiments of the present invention, the central server 500 may further alter the configuration of the original content 110 (even more than the configuration of the calling tool 120) to adapt it to the user's device 10 and/or to the website and web page 200 and original content 110.

The server 500 may be operatively associated with the network page 200, the container landing-page 100, the calling tool 120, the advertiser's communication device 20 and with at least one database 550 enabling to store data relating to the initiated calls, registered advertisers 21 and their devices 20, and enabling advertisers 21 or any other authorized user 11 to retrieve data stored therein.

According to some embodiments of the invention, the central server 500 may additionally enable maintaining a multiplicity of container landing-pages 100 with add-on calling tools 120 associated with one or more advertisers 21. The server 500 may additionally enable advertisers 21 to register and open an account from which they can pay for the maintenance of the calling tools 120 in their container landing-pages 100, control the features of the calling tool 120 in their landing-page containers 100 or any other feature of the landing-page 100 (e.g. the graphics, animation, text content, audio content, sound and/or visual effects, activation conditions and the like), etc.

According to some embodiments of the invention, the calling tool 120 may be enabled and disenabled (e.g. activated or deactivated and presented or hidden) according to validation conditions, which may validate or invalidate the permission to use the calling tool 120 in the container landing-page 100 depending upon external information retrieved from the server 500 such pre-paid balance of the advertiser's 21 account, predefined schedules of the advertiser 21 and the like and/or other external validation conditions enabling or disenabling the initiation of calls or the activation of the calling tool 120 (e.g. calls-traffic loads in the communication network 99, identification of an unauthorized user 11 by identification of his IP, cookies stored by calling-tool 120 at user's 11 machine, and the like).

According to some embodiments of the invention, the system 1000 may further comprise at least one call system 600 (e.g. an operator of one or more communication networks 98), which may be operatively associated with the server 500 enabling to transmit data to the server 500 and thereby update the server 500 regarding calls and accounts related information such as parameters indicating the traffic loads, the users' 11 call length and status and/or any other communication devices' addresses and sources and the like, as known in the art.

According to some embodiments of the invention, all validation conditions may be checked by the server 500, where the server 500 may validate or invalidate the activation of the calling tool 120 according to predefined rules and priorities (e.g. advertisers 21 that are in monetary debt may be a first priority for disenabling their calling tools 120 or calls to advertiser 21 over the network 99 reach a predefined maximum limit etc.).

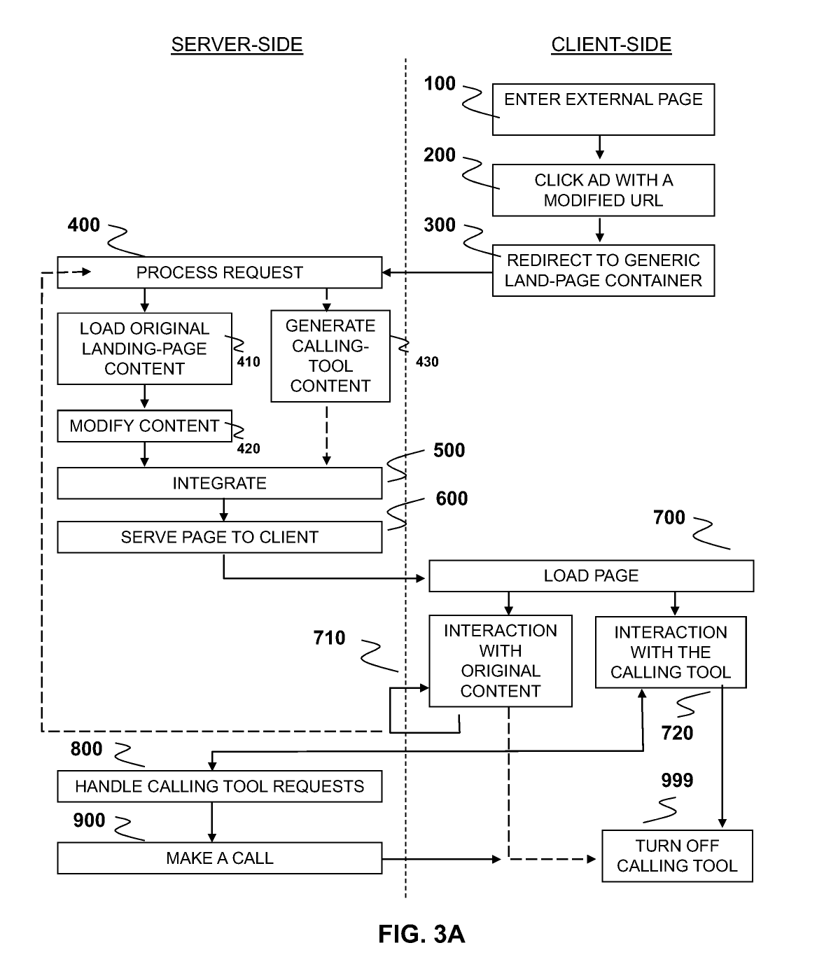

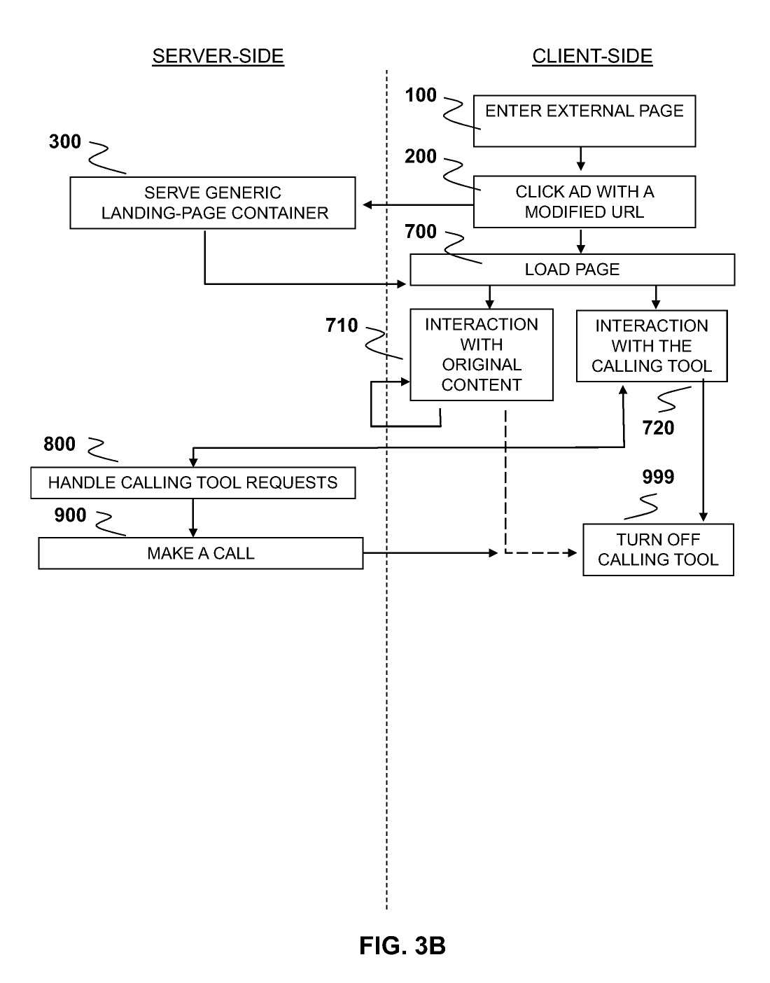

Reference is now made to FIG. 3A, which schematically illustrates a method for redirection to and creation of landing-page containers with add-on calling tools, according to some embodiments of the invention. These embodiments describe a method which may be server intensive but also allows better customization of original content to the display and interaction with the calling tool in the landing-page container, relative to other embodiments described in FIG. 3B.

According to these embodiments the process may comprise the steps of:

Entering the external page 100

Clicking the ad with the modified URL 200 which leads to the landing-page container network page with the original link to the original content as parameter 300.

Processing the request at the server side 400 by loading the original content 410, modifying it 420 to allow appropriate integration with the calling tool generated content 430. At this stage, the server may decide not to generate the calling-tool content 430 and not to modify the original page content 420, but rather redirect to or leave as-is the original content URL based on server-logic which accounts for different conditions as to the enablement of the calling-tool, as described and illustrated in different embodiments of the invention. As the server redirects to the original URL, the resulted page would not contain the calling tool and the calling tool may be regarded as disabled by the server. This ability to stop serving the calling tool content 430 may be used either at first serving of the landing-page container 300 or alternatively as the user follows a hyperlink (which was modified at 420) from within the landing-page, during an interaction with the original content at 710. For instance, allowing only the first page of the original content to be displayed with the calling tool, or allowing only specific links in the original content to be followed with the calling-tool. Other modifications in the original content 420 may include modifying transparency properties, modifying background colors, modifying z-axe precedence and the like to achieve a better integration, display or interaction with the calling-tool in the landing-page container.

Integrating 500 both contents to a single network page: the landing-page container and serving the outcome to the client browser 600.

Loading the page at the client side 700.

User interacting with the original content 710 and the calling tool 720. Interaction with the original content may include serving other inner or external links by the server, as aforementioned in step 400, and marked with a dashed arrow 710-400. Interaction with the calling tool may involve interaction and communication with the server 800. The calling tool may be turned off or be disabled 999 among other conditions elaborated in different embodiments of the present invention, as a result of an interaction with the original content, for example, by an execution of a disablement command embedded while the original content was modified 420.

Reference is now made to FIG. 3B, which schematically illustrates a method for redirection to and creation of landing-page containers with add-on calling tools, according to some embodiments of the invention. These embodiments describe a method which may be less server-intensive but also allows lower degree of original content customization to display and interact with the calling tool in the landing-page container, relative to other embodiments described in FIG. 3A.

According to these embodiments the process may comprise the steps of:

Entering the external page 100.

Clicking the ad with the modified URL 200 which leads to the landing-page container network page with the original link to the original content as parameter 300.

Serving a generic landing-page container by the server 300. In the embodiments described in FIG. 3B, the server may not require to alter the original content of the landing-page (except for encoding the original content URL in the container) but rather to serve every request with the same container resource. Moreover, in case that the URL parameter of the original content is part of the landing-page container's URL and in case that the computer code that orders to load this original content's parameter is client-side script language (such as JavaScript, VBScript, Java Applet, etc) then the very same landing-page container can be served as-is, requiring no server-side scripting at all (such as PHP, ASP, JSP, etc). Therefore the landing-page container can resides at various network locations supported by various operation systems and server types (not just at system server 500), easing server loads and bandwidth.

The main drawbacks of this method are that in most cases, due to cross-domain security policy, interaction with the original content cannot affect the display or behavior of the calling tool. For example, in these cases, turning off calling tool 999 may not be achieved as an outcome of an interaction with the original content 710 (dashed arrow 710-999).

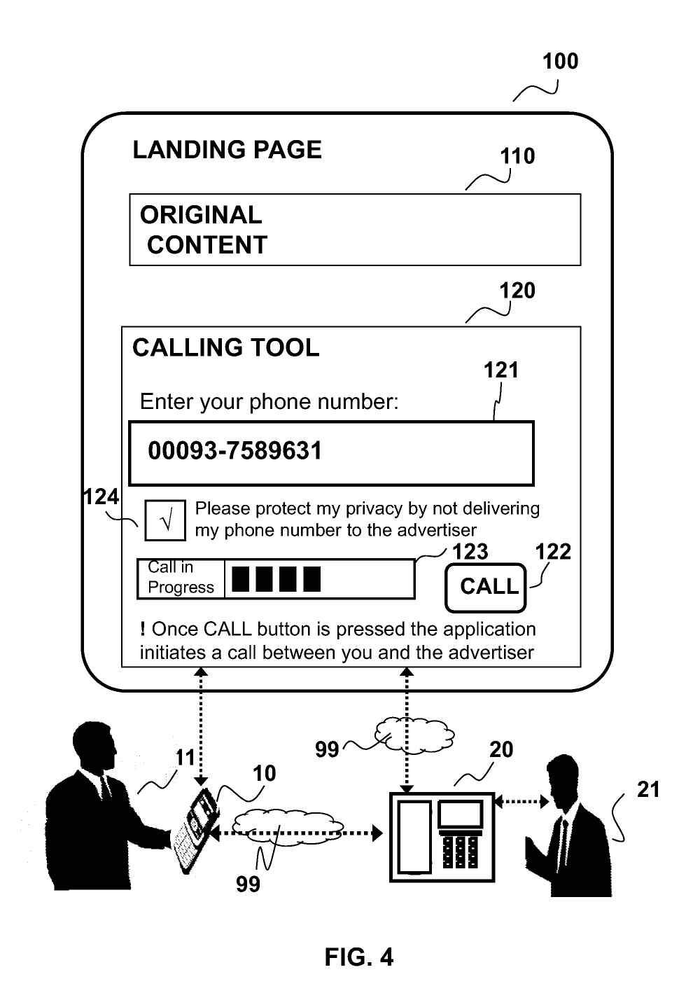

Reference is now made to FIG. 4, which schematically illustrates a calling landing-page container with an input interface, according to some embodiments of the invention. According to these embodiments, the calling tool 120 may comprise an interface comprising an input field 121 (e.g., a text field that may be utilizing an internet cookie), a virtual call button 122, and a call progress indicator 123. The input field 121 may allow the user 11 to input his/her communication code such as his/her phone number and pressing the call button 122 may allow the user 11 to approve the call.

According to embodiments, the last inputted communication code, entered by the user 11 into the input field 121, which includes the communication details required for establishing communication with the user's communication device 10 (e.g. phone number, VoIP account identifier, etc.) may be stored and automatically reappear in the input field 121.

According to embodiment, a web cookie may enable checking the user's 11 validity (e.g. whether this is a problematic user 11 defining the user as “invalid” in the system according to predefined user-invalidation rules), for example, using the user's input communication code or the result and length of former calls made using the calling-tool 120.

According to some embodiments of the invention, as illustrated in FIG. 4, once the user 11 inputted his/her phone number and pressed the call button 122, the system 1000 may allow automatically initiating a call between the advertiser's communication device 20 and the user's 11 phone (as the user's communication device 10). For example, the call may be carried out by the call system 600 enabling to execute a call from the advertiser's communication device 20 to the user's communication device 10 through any communication network(s) 98 on the expense of the advertiser 21. Such call initiation may be the result of an automatic decision-making process, carried out by server 500 based on data stored in database 550 and possibly further data that may be provided by the calling tool 120 to the server 500 (for example—data regarding the client side, such as previous call history, timing etc), while such decision-making process may further take in contemplation rules related to the advertiser 21, the timing of the call and other circumstances. The call initiation may by, in some embodiments of the invention, subject to user's 11 choices in regard to the exposure of his phone number to the advertiser 21. For example, as illustrated in FIG. 4, the calling tool 120 may contain a check-box 124 related to user's 11 privacy, in which the user can mark his choice in that respect. As further illustrated in FIG. 4, the call initiation may be monitored by a visual notification 123 to user 11 in regard to the progress of the call and/or the call connection. The call initiation may be subject to a decision process.

The call progress indicator 123 may facilitate in indicating the communication status and progress, as known in the art, once the call is initiated.

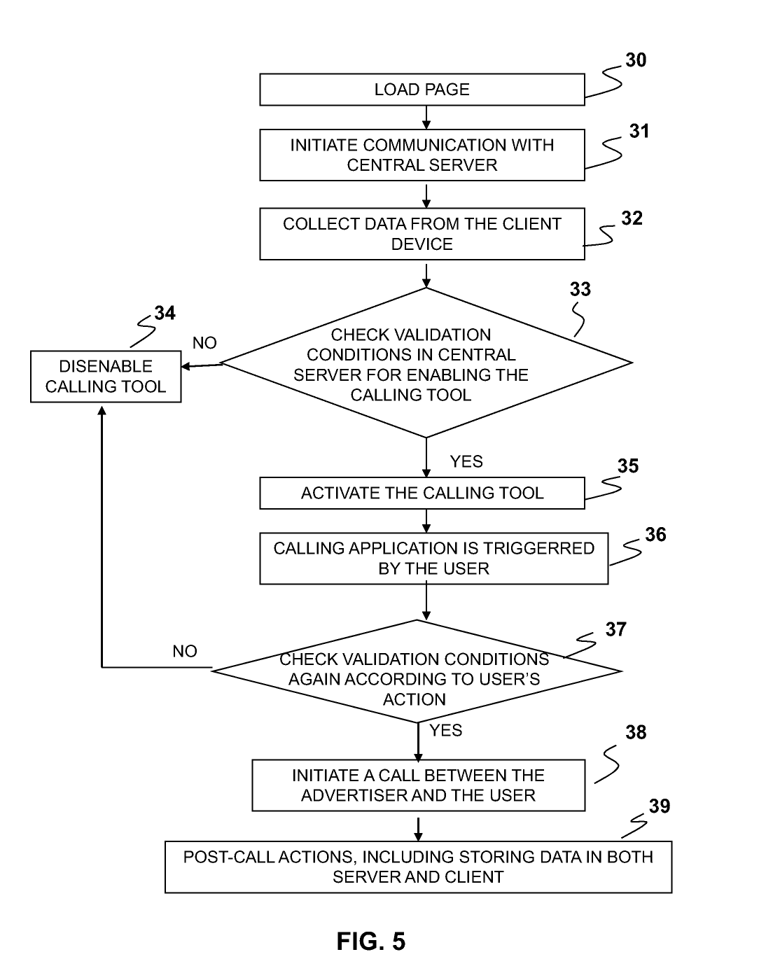

Reference is now made to FIG. 5, which schematically illustrates a process of enabling of the calling tool 120 of a landing-page container 100 and the initiation of a call, according to some embodiments of the invention. According to these embodiments the process may comprise the steps of:

Entering the landing-page container network page that comprises both the original content and the calling tool 30;

Initiating communication with the central server 500 and reporting to the server 31;

Collecting data from user's device 32 (for example—the device's IP address, geographical location, referral domain address, former history stored at client-side of user's telephone calls via the calling tool 120 etc);

Checking initial validation condition(s) 33 for presenting the calling tool 120 according to predefined rules (e.g. the advertiser's 21 schedule or max concurrent-calls limit);

Disenabling the calling tool 34, once the validation check results in a non-validated enablement or no communication with the server 500, where the disenabling includes deactivation of the calling tool 120, which may further include hiding of the calling tool's 120 indication in the landing-page container 100;

Enabling the calling tool 35, once the validation check results in a validation, where the enabling of the calling tool 120 includes activation of the calling tool 120;

Activate the calling tool 36 (carried out by the user 11, who may perform an activation action such as clicking the calling tool 120 and/or inserting his/her communication code (e.g. phone number);

Checking initiation validation 37 according to the user's 11 actions (e.g. checking the validity of the telephone number entered by the user or the probability for fraud or misuse according to user's 11 data and actions);

Disenabling the calling tool 34, once the validation check results in a non-validated enablement; and Initiating a call between the user's device and the advertiser's device 38.

According to embodiments, additional actions may be taken during/after the call is initiated 39 such as, for example, presenting an indication indicating to the user 11 that the call is in progress and/or after the call such as, for example, storing the call data in the server 500 for later billing and calls' history analysis, adding information to the accumulative learning of the system (such as user's behavior) and storing client-side information in order to allow automatic future interaction with the container landing-page 100 (phone-numbers that resolved in a short unsuccessful calls, remembering last phone number typed by user for future one-click-to-call interaction).

According to some embodiments of the invention, the user's communication device 10 may be the computer he/she uses to enter the external network page 200, where the advertiser's communication device 20 details are registered in the server 500 enabling to initiate communication between the devices 10 and 20 by executing a Voice over IP (VoIP) technology, for example, enabling automatic communication through the landing-page container 100. In a case, in which the user's communication device 10 is a fixed line telephone handset, or a mobile handset, a callback procedure may be used in order to connect the advertiser's telephone handset 20 and the user's telephone handset 10 by calling one handset, then calling the other handset and then connecting both handsets, as known in the art. The order in which both handsets are called (which one is first) may be a case-specific parameter which is stored at database 550 and delivered by sever 500.

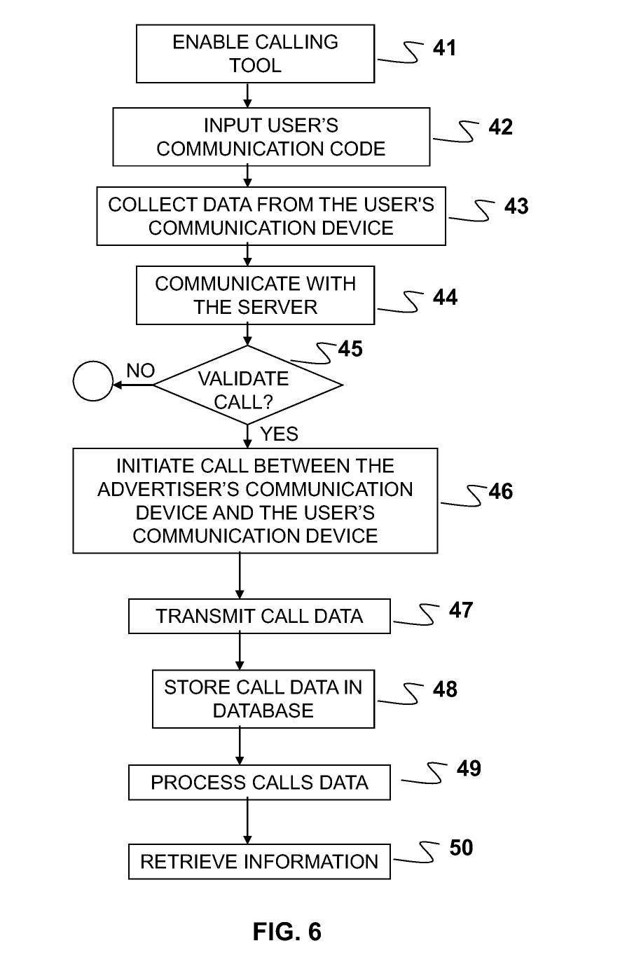

Reference is now made to FIG. 6, which schematically illustrates a process of initiating a call to the user's communication device 10, according to some embodiments of the invention. According to these embodiments, the process may comprise the steps of:

Enabling the call tool 41, where the user 11 activates the tool 120 (e.g. by hovering over a predefined area on the screen page of the landing-page container 100, for example, a predefined area within 100, with the cursor 50);

Inputting the user's communication code (e.g. phone number) 42, where the user enters his/her communication code into the input field 121;

Collecting data stored at user's communication device 43, for example, by utilizing a cookie as known in the art, for complementary information in regard to the approval of the call;

Communicating with the server 44 including retrieving information from database 550 in order to gather all information required for the decision-making process relating to the call initiation validation;

Once the call is approved 45 (e.g. when the call button is pressed by the user 10 and no reason has been found in system 1000 for invalidating the call)—initiating a call 46 from the advertiser's communication device 20 to the user's communication device 10;

Transmitting call data 47. where the call system 600 enables transmitting the call data (e.g. phone number, call length, call status, other details, time parameters, results of the call in sales terms and the like) to the server 500;

Storing the call data 48 where the server 500 stores the data in the database 550; and

Processing calls data 49, where the server 500 enables processing all the call data stored (e.g. using statistical modules to process the data associated to the advertiser 21 to output statistics enabling the advertiser user to measure the efficiency of the banner 100 as a sales promoter and the like); and

Retrieving information from the database 50, where the system 1000 allows users 11 and/or advertisers 21 to retrieve and view the resulting processing results (E.g. the statistical information of each landing-page container 100 redirected from each network page 200).

Reference is now made to FIG. 7, which schematically illustrates an ad generator and a calling landing-page customization tool, according to some embodiments of the invention. The ad manager 300 may be any software tool (e.g. a website) that allows a multiplicity of advertisers 21 to create, manage and customize their landing-pages 100 or specifically their container landing-page 100 calling tools 120.

According to some embodiments of the invention, as illustrated in FIG. 7, the ad manager 300 may comprise at least one of: a landing-page customization tool 310 comprising an ad generation module 311 and a calling tool customizing module 312; a control module 320; and an account managing module 330.

The landing-page customization tool 310 may enable advertisers 21 to create, customize and update their landing-page containers 100 and/or the calling tools 120 including defining and updating the details related to utilizing communication networks 98 and configurations for executing and initiating of calls from and to a variety of communication devices 10 and 20.

According to some embodiments of the invention, the ad generation module 311 may enable the advertiser 21 to create, customize and/or update the content and link of the advertisement in external web page 200. For example, define an existing landing-page link to be used as the original content 110 and/or edit or add to its content (e.g. add the texts, create animated films, add audio and/or graphic messages and the like). The ad generation module, may retrieve the original ad (e.g. text ad or a banner) with its hyperlink 212 modified to redirect to a generic landing-page container 100 (instead of the original content 110) in order to present the original content 110 within the container once said hyperlink is clicked or followed. Alternatively, the ad generation module may be a simple URL modifier which may provide an alternative URL for the landing-page container in exchange to the original content 110's URL provided by the advertiser 21 (e.g. see URL example given in FIG. 1).

According to some embodiments of the invention, the calling tool customization module 312 may enable the advertiser 21 to create, update and/or customize the calling tool 120 and the features and parameters of the calling tool 120 such as defining or selecting the activation conditions, defining the graphics of the calling tool 120, defining the types of communication networks 98 and devices 20 available to the advertiser 21, inputting and updating the destination phone number or identification and communication details of the advertiser's communication device(s) 20 and the like.

The landing-page customization tool 310 may use GUI applications to allow graphical and audio editing and creating tools. Alternatively, definitions and settings may be communicated to the banner customization tool 310 without a GUI, for example using an Internet web-service or configuration files loaded or downloaded to it.

According to some embodiments of the invention, the control module 320 may be associated with the landing-page customization tool 310 and to the central server 500 enabling to monetize and supervise the ads 200 made by the landing-page customization tool 310 and the calls initiated by the calling tool 120 (e.g. receive statistics about the calls/clicks/impressions of the banners, disable/enable the calling tool in each landing-page container 100, edit its settings, associate landing-pages in groups, etc).

According to some embodiments of the invention, the account manager module 330 may be a user interface enabling the advertiser 21 to open and manage a personal account comprising all modified ads and landing-page containers associated with the advertiser 21, pay for the services of the landing-page customization tool 300 and/or the calls made by the calling tools (or by other metrics known in the art, such as paying for impressions, leads, minutes talked, click-throughs) of the landing-page 100, and the like. Additionally, the account manager module 330 may further enable managing the accounts of all advertisers 21 and transmit the monetary condition of each advertiser 21 to the server 500 to allow it to calculate and consider this data as at least some of the validation conditions.

The system 1000 may allow upgrading already existing and designed ads of advertisers 21 that do not include the calling applicability in its redirection and the calling tool 120 by integrating the link of the landing-page container 100 into the ad 200 file (e.g. flash file). This may be carried out using any codes and applications integration technologies, depending of the computer program language and features of each ad 200. For example, according to a method and system described in Patent Application No. 61/006,379, filed Jan. 10, 2008, which is incorporated by reference herein in its entirety.

According to embodiments, the system 1000 may further enable a multiplicity of advertisers 21 to share information regarding potential customers, by allowing analyzing stored data such as: user's communication codes (e.g. user's phone number to allow a single-click phone-call initiation), history of calls, history of the quality of calls (e.g. supporting fraud and miss-use analysis by storing prior call status and duration at the client machine) etc.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. A method for selectively allowing a user of an electronic device to initiate a telephone call with an advertiser, the method comprising:
receiving from said electronic device a signal indicating that the user clicked on an advertisement associated with said advertiser;
retrieving an original content associated with said advertiser;
based on one or more calling tool enabling conditions, determining whether to enable or disable a calling tool intended to be presented in association with said original content;
if it is determined to disable the calling tool, then serving to said electronic device the original content excluding the calling tool;
if it is determined to enable the calling tool, then serving to said electronic device a landing-page container which includes the original content and the calling tool.

2. The method of claim 1, wherein the one or more calling tool enabling conditions comprise one or more of:
a condition related to an event associated with the user of said electronic device;
a condition related to an event predefined by said advertiser.

3. The method of claim 2, wherein the condition related to an event associated with the user of the electronic device comprises one or more of:
a condition related to an historical usage of the calling tool by said user;
a condition related to an historical abuse of the calling tool by said user;
a condition related to an historical fraudulent of the calling tool by said user;
a condition related to an historical legitimate usage of the calling tool by said user.

4. The method of claim 2, wherein the condition related to an event predefined by said advertiser comprises one or more of:
a condition related to a time-of-day predefined by said advertiser for calling tool enablement or disablement;
a condition related to a day-of-week predefined by said advertiser for calling tool enablement or disablement;
a condition related to a calendar date predefined by said advertiser for calling tool enablement or disablement;
a condition related to a number of concurrent calls performed towards a call center of said advertiser;
a condition related to a cumulative number of calls received by said advertiser;
a condition related to a number of calls received by said advertiser per pre-defined time-period;
a condition related to a number of times that the calling tool was presented to users of electronic devices in association with said advertiser;
a condition related to a balance in an account of said advertiser.

5. The method of claim 2, wherein the one or more calling tool enabling conditions comprise one or more of:
a condition related to the original content;
a condition related to a type of browser utilized by the electronic device;
a condition related to an Internet Protocol (IP) address of the electronic device;
a condition related to a geographic location of the electronic device;
a condition related to the web-site from which the user clicked on said advertisement.

6. The method of claim 1, comprising:
based on the one or more calling tool enabling conditions, constructing said landing-page container to include said original content and said calling tool, wherein said original content is initially visible to said user, and wherein said calling tool is initially hidden from said user and becomes visible to said use upon performance of a particular interacting operation by said user.

7. The method of claim 1, comprising:
based on the one or more calling tool enabling conditions, constructing said landing-page container to operate as a dual-functioning landing-page having: (a) a first function, of a landing page absent a calling tool component, if it is determined to disable the calling tool; and (b) a second function, of a landing page having a calling tool component, if it is determined to enable the calling tool.

8. The method of claim 1, comprising:
if it is determined to enable the calling tool, constructing said landing-page container by performing one or more operations selected from:
adapting the calling tool to the original content;
adapting the calling tool to the electronic device.

9. The method of claim 1, comprising:
retrieving said one or more calling tool enabling conditions from a database which stores one or more of:
a plurality of calling tool enabling conditions associated with a plurality of advertisements, respectively; and
a plurality of calling tool enabling conditions associated with a plurality of advertisers, respectively;
receiving from said advertiser: (a) data representing the advertisement, and (b) an original hyperlink submitted by the advertiser and indicating an original landing-page predefined by the advertiser; and
constructing a modified hyperlink to be associated with said advertisement instead of the original hyperlink, wherein the modified hyperlink comprises encoding of the original hyperlink, wherein the modified hyperlink directs to the landing-page container if it is determined to enable the calling tool.

10. (canceled)

11. The method of claim 1, comprising:
subsequent to determining to enable the calling tool, receiving from the electronic device a user request to activate the calling tool; determining that the user request is non-legitimate, and in response, disabling the previously-enabled calling tool;
wherein serving the landing-page container comprises: serving to the electronic device a landing-page container which comprises directives requesting at least a portion of the original content, wherein at least a portion of the original content is directly obtained by said electronic device from a website associated with said advertiser.

12. (canceled)

13. A system for selectively allowing a user of an electronic device to initiate a telephone call with an advertiser, the system comprising:
a server to receive from said electronic device a signal indicating that the user clicked on an advertisement associated with said advertiser;
to retrieve an original content associated with said advertiser;
based on one or more calling tool enabling conditions, to determine whether to enable or disable a calling tool intended to be presented in association with said original content;
if it is determined to disable the calling tool, then to serve to said electronic device the original content excluding the calling tool;
if it is determined to enable the calling tool, then to serve to said electronic device a landing-page container which includes the original content and the calling tool.

14. The system of claim 13, wherein the one or more calling tool enabling conditions comprise one or more of:
a condition related to an event associated with the user of said electronic device;
a condition related to an event predefined by said advertiser.

15. The system of claim 14, wherein the condition related to an event associated with the user of the electronic device comprises one or more of:
a condition related to an historical usage of the calling tool by said user;
a condition related to an historical abuse of the calling tool by said user;
a condition related to an historical fraudulent of the calling tool by said user;
a condition related to an historical legitimate usage of the calling tool by said user.

16. The system of claim 15, wherein the condition related to an event predefined by said advertiser comprises one or more of:
a condition related to a time-of-day predefined by said advertiser for calling tool enablement or disablement;
a condition related to a day-of-week predefined by said advertiser for calling tool enablement or disablement;
a condition related to a calendar date predefined by said advertiser for calling tool enablement or disablement;
a condition related to a number of concurrent calls performed towards a call center of said advertiser;
a condition related to a cumulative number of calls received by said advertiser;
a condition related to a number of calls received by said advertiser per pre-defined time-period;
a condition related to a number of times that the calling tool was presented to users of electronic devices in association with said advertiser;
a condition related to a balance in an account of said advertiser.

17. The system of claim 14, wherein the one or more calling tool enabling conditions comprise one or more of:
a condition related to the original content;
a condition related to a type of browser utilized by the electronic device;
a condition related to an Internet Protocol (IP) address of the electronic device;
a condition related to a geographic location of the electronic device;
a condition related to the web-site from which the user clicked on said advertisement.

18. The system of claim 13, wherein, based on the one or more calling tool enabling conditions, the server is to construct said landing-page container to include said original content and said calling tool, wherein said original content is initially visible to said user, and wherein said calling tool is initially hidden from said user and becomes visible to said use upon performance of a particular interacting operation by said user.

19. The system of claim 13, wherein, based on the one or more calling tool enabling conditions, the server is to construct said landing-page container to operate as a dual-functioning landing-page having: (a) a first function, of a landing page absent a calling tool component, if it is determined to disable the calling tool; and (b) a second function, of a landing page having a calling tool component, if it is determined to enable the calling tool.

20. The system of claim 13, wherein, if it is determined to enable the calling tool, then the server is to construct said landing-page container by performing one or more operations selected from:
adapting the calling tool to the original content;
adapting the calling tool to the electronic device.

21. The system of claim 13, wherein the server is to retrieve said one or more calling tool enabling conditions from a database which stores one or more of:
a plurality of calling tool enabling conditions associated with a plurality of advertisements, respectively; and
a plurality of calling tool enabling conditions associated with a plurality of advertisers, respectively;
wherein the server is to receive from said advertiser: (a) data representing the advertisement, and (b) an original hyperlink submitted by the advertiser and indicating an original landing-page predefined by the advertiser;
wherein the server is to construct a modified hyperlink to be associated with said advertisement instead of the original hyperlink, wherein the modified hyperlink comprises encoding of the original hyperlink, wherein the modified hyperlink directs to the landing-page container if it is determined to enable the calling tool.

22. (canceled)

23. The system of claim 13, wherein, subsequent to determining to enable the calling tool, the server is to receive from the electronic device a user request to activate the calling tool; to determine that the user request is non-legitimate, and in response, to disable the previously-enabled calling tool;
wherein the server is to serve to the electronic device the landing-page container which comprises directives requesting at least a portion of the original content, and wherein at least a portion of the original content is directly obtained by said electronic device from a website associated with said advertiser.

24. (canceled)
